(19) United States
(12) Patent Application Publication
(10) Pub. No.: US 2007/0162599 A1
(43) Pub. Date: Jul. 12, 2007

(54) Distributing a policy decision function in an IP multimedia subsystem

(75) Inventor: Hai Duong Nguyen, Plano, TX (US)

Correspondence Address: CONLEY ROSE, P.C., 5700 GRANITE PARKWAY, SUITE 330, PLANO, TX, 75024, US

(73) Assignee: Samsung Electronics Co., Ltd.

(21) Appl. No.: 11/329,627

(22) Filed: Jan. 11, 2006

(51) Int. Cl. G06F 15/173

(52) U.S. Cl. 709/225

(57) ABSTRACT

An Internet Protocol (IP) Multimedia Subsystem (IMS) is provided that includes a plurality of separate central processing units (CPUs). The IMS also includes a logical Policy Decision Function (PDF) component comprising a plurality of physical PDF network elements, each physical PDF network element execute on separate CPUs of the plurality of CPUs. A front end node is operable to determine which one of the plurality of physical PDF network elements is an intended recipient of a message by using identification information in an authorization token portion of the message. A distribution component is operable to select one of the plurality of physical PDF network elements according to a load sharing policy.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### FIELD OF THE INVENTION

The present disclosure relates to IP telephony. More specifically, but not by way of limitation, a method and system are provided that allow the distribution of a Policy Decision Function in an Internet Protocol Multimedia Subsystem.

### BACKGROUND OF THE INVENTION

Internet Protocol (IP) telephony has emerged as an alternative to the traditional telephony that uses the public switched telephone network (PSTN). IP telephony uses data packet-based technologies to exchange voice, fax, audio, video, gaming, and other data (i.e., multimedia) during a user session involving two or more users. Unlike PSTN-based calls, the messages transmitted in an IP telephony-based message exchange do not travel in a dedicated circuit between two users. Instead, a message sent by a transmitting party is broken into data packets that may travel over different paths through a network before being reassembled and delivered to a receiving party.

The IP Multimedia Subsystem (IMS) is a standardized architecture for providing both mobile and fixed multimedia services that many telephony service providers are beginning to implement. The IMS architecture is defined as a collection of different functions (i.e., network elements) that communicate using standard protocols. There is no required one-to-one mapping between these functions and network nodes (i.e., computer systems) in an actual implementation of the IMS architecture. A service provider may combine multiple functions on a single node or split a single function across multiple nodes. Therefore, systems and methods for implementing the IMS functions are desirable.

### SUMMARY OF THE INVENTION

According to one embodiment, an Internet Protocol (IP) Multimedia Subsystem (IMS) is provided. The IMS includes a logical Policy Decision Function (PDF) component that includes a plurality of physical PDF network elements. The IMS also includes a front end node operable to determine which one of the plurality of physical PDF network elements is an intended recipient of a message by using identification information in an authorization token portion of the message.

According to another embodiment, a method for distributing Policy Decision Function (PDF) in an Internet Protocol (IP) Multimedia Subsystem (IMS) is provided. The method includes providing a plurality of physical PDF network elements that comprise a logical PDF. Each one of the plurality of physical PDF network elements executes on a separate central processing unit (CPU). The method includes receiving a message intended for one of the plurality of physical PDF network elements. The method includes determining from an identifier in the message which of the plurality of physical PDF network elements the message is intended for. The method also includes delivering the message to the intended one of the plurality of physical PDF network elements.

According to still other embodiments, an Internet Protocol (IP) Multimedia Subsystem (IMS) is provided that includes a plurality of separate central processing units (CPUs). The IMS also includes a logical Policy Decision Function (PDF) component comprising a plurality of physical PDF network elements, each physical PDF network element execute on separate CPUs of the plurality of CPUs. A front end node is operable to determine which one of the plurality of physical PDF network elements is an intended recipient of a message by using identification information in an authorization token portion of the message. A distribution component is operable to select one of the plurality of physical PDF network elements according to a load sharing policy.

These and other features and advantages will be more clearly understood from the following detailed description taken in conjunction with the accompanying drawings and claims.

### BRIEF DESCRIPTION OF THE DRAWINGS

For a more complete understanding of the presentation and the advantages thereof, reference is now made to the following brief description, taken in connection with the accompanying drawings in detailed description, wherein like reference numerals represent like parts.

FIG. 1 illustrates a simplified IMS architecture according to the prior art.

FIG. 2 illustrates a simplified architecture of a CSCF network element in the IMS architecture of FIG. 1 according to the prior art.

FIG. 3 is a simplified example of IMS communication involving two roaming IMS mobile users according to the prior art.

FIGS. 4A and 4B illustrate IMS systems having a distributed PDF in accordance with some embodiments of the present disclosure.

FIG. 5 illustrates the format of a PDF Session Identifier included in an authorization token in accordance with some embodiments of the present disclosure.

FIGS. 6A and 6B illustrate message routing using a distributed PDF in accordance with some embodiments of the present disclosure.

FIG. 7 is a block diagram of a computer system operable for embodiments of the present disclosure.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical, wireless, or other electrical connection. Thus, if a first device couples to a second device, that connection may be through a direct electrical connection, through an indirect electrical connection via other devices and connections, through an optical electrical connection, or through a wireless or other electrical connection.

Certain standard nomenclature known to one of skill in the art of IP telephony is used throughout the following description and claims and in the accompanying drawings. This nomenclature, along with standard abbreviations for the nomenclature, is summarized in Table 1.

TABLE 1

| Nomenclature | Abbr. | Summary |
|---|---|---|
| Application Level Gateway | ALG | application specific entities that modify |
| | | application level payloads and perform |
| | | whatever else is necessary to get the |
| | | application running across disparate |
| | | address realms of different IP versions. |
| Application Server | AS | a network element that hosts and execute |
| | | services; may be located in the home |
| | | network or in an external third-party |
| | | network. |
| Authorization token | | consists of the IMS session identifier and |
| | | the PDF identifier; used for authorizing the |
| | | QoS for the IP flow(s). |
| Bearer Control Function | BCF | a network element that performs QoS |
| | | management within the IP Backbone network. |
| Common Open Policy Service | COPS | a simple query and response protocol |
| protocol | | used to exchange policy information |
| | | between a policy server (Policy Decision |
| | | Point) and its clients (Policy Enforcement |
| | | Points). |
| Call Session Control Function | CSCF | a network element responsible for |
| | | maintaining a SIP call; provides session |
| | | control for subscribers accessing services |
| | | within an IMS network. |
| Gateway GPRS Support Node | GGSN | supports the edge routing function of the |
| | | GPRS network. To external packet data |
| | | networks the GGSN performs the task of |
| | | an IP router for external packet data |
| | | networks; also provides firewall and |
| | | filtering functionality to protect the integrity |
| | | of the GPRS core network. |
| Go interface | | interface between PDF and GGSN. |
| General Packet Radio Service | GPRS | a mobile data service for GSM mobile |
| | | phones; sometimes referred to as 2.5G, a |
| | | technology between the second (2G) and |
| | | third (3G) generations of mobile |
| | | telephony. |
| Home Subscriber Server | HSS | the master database for a given user |
| | | containing the subscription-related |
| | | information to support the network entities |
| | | actually handling calls/sessions. |
| Interrogating Call Session | I-CSCF | a SIP proxy CSCF located at the edge |
| Control Function | | of an administrative domain that serves as |
| | | an entry point for all SIP packets to the |
| | | domain. Its IP address is published so that |
| | | remote servers (e.g., a P-CSCF in a |
| | | visited domain, or a S-CSCF in a foreign |
| | | domain) can find it, and use it as an entry |
| | | point. The I-CSCF queries the HSS to |
| | | retrieve the user location in order to route |
| | | a SIP request to its assigned S-CSCF. |
| Mobile Equipment | ME | the hardware element of a mobile station |
| | | and comprises of keyboard, screen, radio, |
| | | circuit boards and processors etc. |
| Proxy Call Session Control | P-CSCF | a SIP proxy in CSCF that is the first point |
| Function | | of contact for the IMS terminal; may be |
| | | located in the visited network in full IMS |
| | | networks or in the home network if the |
| | | visited network isn't IMS compliant yet; |
| | | assigned to the terminal in the PDP |
| | | context in GPRS. |
| Policy Decision Function | PDF | a logical policy decision element that uses |
| | | standard IP mechanisms to implement |
| | | policy in the IP media layer; the PDF |
| | | makes decisions in regard to network |
| | | based IP policy using policy rules, and |
| | | communicates these decisions to the PEP |
| | | in the GGSN. |
| Packet Data Protocol | PDP | one protocol of the GPRS protocols. |
| Policy Enforcement Point | PEP | a logical entity that enforces policy |
| | | decisions made by the PDF. It resides in |
| | | the IP BS Manager of the GGSN. |
| Public Switched Telephone | PSTN | international telephone system based on |
| Network | | copper wires carrying analog voice data; |
| | | also referred to as Plain Old Telephone |
| | | Service (POTS). |
| Quality of Service | QoS | the collective effect of service |
| | | performances which determine the degree |
| | | of satisfaction of a user of a service; |
| | | characterized by the combined aspects of |
| | | performance factors applicable to all |
| | | services such as: service operability |
| | | performance, service accessibility |
| | | performance, service retention |
| | | performance, service integrity |
| | | performance, and other factors specified to |
| | | each service. |
| Radio Access Network | RAN | performs the radio functionality of the |
| | | network, as well providing the connection |
| | | to the core network; typically includes a |
| | | controller that is either a Radio Network |
| | | Controller (RNC) or a Base Station |
| | | Controller (BSC) and several |
| | | transmitter/receivers. |
| Serving Call Session Control | S-CSCF | a SIP server located in the home network |
| Function | | that also performs session control; |
| | | downloads and uploads user profiles |
| | | to/from the HSS. |
| Serving GPRS Support Node | SGSN | tracks the location of an individual mobile |
| | | station and performs security functions |
| | | and access control. |
| Session Initiation Protocol | SIP | signaling protocol used to create, manage |
| | | and terminate sessions in an IP network. |
| User Equipment | UE | Any end user device (e.g., mobile phone, |
| | | personal digital assistant, laptop computer, |
| | | desktop computer, etc.) that connects to |
| | | IMS. |

### DETAILED DESCRIPTION OF THE PREFERRED EMBODIMENTS

It should be understood at the outset that although exemplary implementations of embodiments of the present invention are illustrated below, the present system may be implemented using any number of techniques, whether currently known or in existence. The present disclosure should in no way be limited to the exemplary implementations, drawings, and techniques illustrated below, including the exemplary designs and implementations illustrated and described herein, but may be modified within the scope of the appended claims along with their full scope of equivalents.

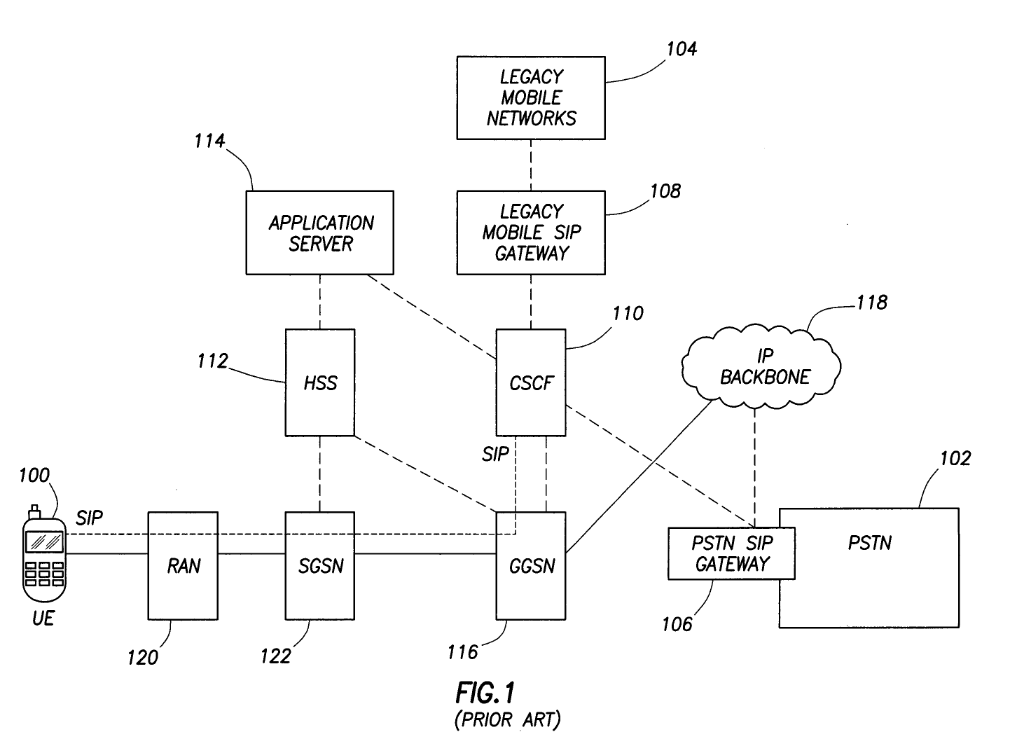

The IP Multimedia Subsystem (IMS) architecture decomposes current and future networking services and devices into functions that are conceptually linked by reference points. The reference points define all message traffic between two functions, including multiple protocols for the different types of message traffic. To better understand and describe aspects of the present disclosure, background including a brief description of prior art systems is provided in FIGS. 1-3. However, it should be appreciated that the described systems are illustrative only and the present system should not be limited to the described system. The present invention may be implemented in other types of systems or in systems configured differently or with different components. FIG. 1 illustrates a simplified IMS reference architecture. In IMS, SIP is used for initiating, maintaining, modifying, and terminating the multimedia services. A user may connect to an IMS network in various ways using IP. Direct IMS terminals such as mobile phones, personal digital assistants, and computers (e.g., UE 100) run SIP User Agents and can connect to an IMS network, whether at a fixed location or roaming. IMS provides connectivity for such terminals via fixed access (e.g., Ethernet, DSL, and cable modems), mobile access (e.g., GSM, GPRS, W-CDMA, and CDMA2000), and wireless access (e.g., WiMAX and WLAN). Phone systems not compatible with IMS, such as PSTN 102 and legacy mobile networks 104, are supported through SIP gateways 106, 108. The IP backbone 118 is an abstraction that represents the set of inter-connecting network administrative domains between two IMS systems.

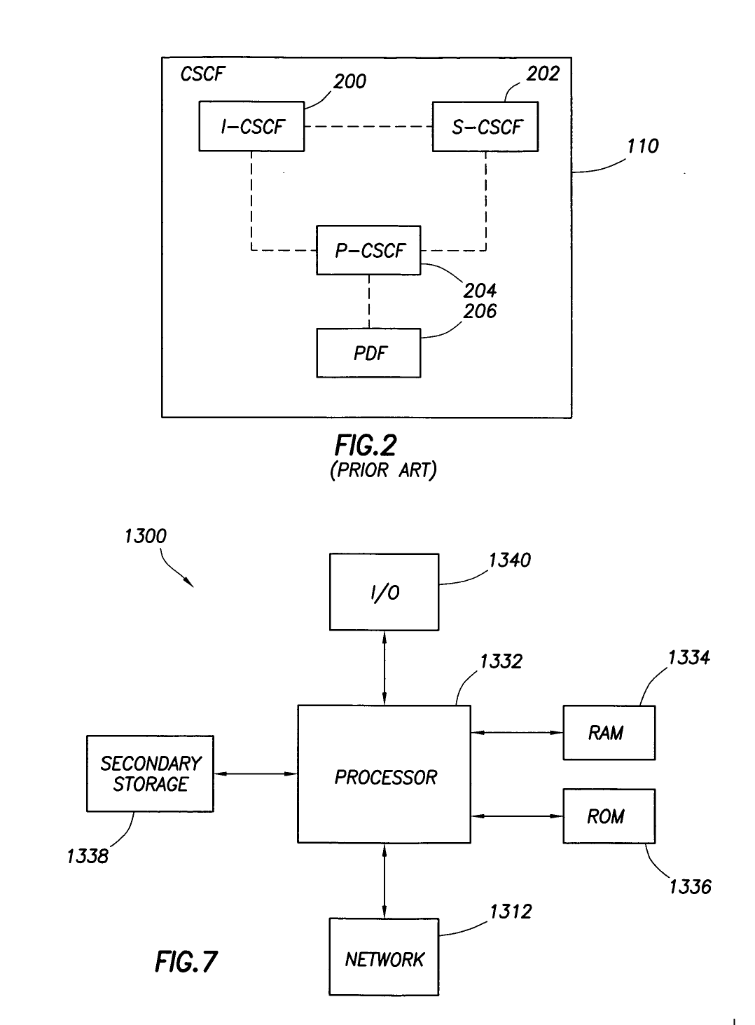

The Call Center Control Function (CSCF) 110 occupies a central position in IMS. The CSCF 110 is a network element responsible for maintaining a SIP call session in the IMS network. As is shown in FIG. 2, CSCF 110 includes an Interrogating CSCF (I-CSCF) 200, a Serving CSCF (S-CSCF) 202, and a Proxy CSCF (P-CSCF) 204. The P-CSCF 204 is the first contact point of a UE 100 within the IMS core network. All signaling events from the UE 100 (e.g., call session initiation, resource allocation, feature activation, or requests for an Application Server (AS) 114 first go to the P-CSCF 204. The P-CSCF 204 forwards SIP messages received from the UE 100 to either the Serving Call Session Control Function (S-CSCF) 202 and/or the Interrogating Call Session Control Function (I-CSCF) 200 based on the type of message.

The I-CSCF 200 provides a contact point within a network that allows subscriber of that network operator, and roaming subscribers, to register. Once a subscriber is registered, the S-CSCF 202 maintains the session state for all IMS services. The I-CSCF 200 typically acts as a SIP proxy. However, in IMS, the main purpose of the I-CSCF 200 is to provide a service locator function. The major functions of the I-CSCF 200 include assigning an S-CSCF to a UE (e.g., UE 100) performing SIP registration, routing a SIP request received from another network to the S-CSCF 202, and routing intra-domain SIP requests between UEs on different S-CSCFs.

The S-CSCF 202 is both a SIP server and a SIP proxy. As a SIP server, the S-CSCF 202 provides session control for subscribers. A major function of the S-CSCF 202 is interacting with network databases such as the Home Subscriber Server (HSS) 112 for mobility and the Access, Authorization and Accounting (AAA) servers (not specifically shown) for security. As a SIP proxy, the S-CSCF 202 relays signals generated by a roaming user for confirmation with the HSS of the roaming users' home network that holds the user's profile. After a user's signaling event is processed by the S-CSCF 200, it may be forwarded to any application servers (e.g., AS 114) or gateways (e.g., gateways 106, 108) required for completion of the requested action or session.

The Policy Decision Function (PDF) 206 is a logical entity of the P-CSCF 204 that functions as a Policy Decision Point (PDP) for service-based local policy control. The PDF 206 makes policy decisions based on session and media related information obtained from the P-CSCF 204 via the interface using the Diameter protocol, and communicates the decision information to the GGSN 116 via the Go Interface (COPS and COPS-PR). When a SIP session is initiated by the UE 100, the PDF 206 generates an authorization token for that session, and the P-CSCF 204 sends the authorization token to the UE 100 in SIP signaling. This authorization token is unique across all PDP contexts associated with an Access Point Name (APN) of the GGSN 116 and may contain information that identifies the PDF 206.

The PDF 206 performs numerous functions in IMS. For example, the PDF 206 receives bearer authorization requests from the GGSN 116 and authorizes these requests using stored session and media related information received from the P-CSCF 204 during SIP session initiation. The PDF 206 also updates these authorization decisions when sessions are modified. In addition, responsive to signaling information received from the P-CSCF 204, the PDF 206 sends commands to the GGSN 116 to perform such operations as opening or closing IP bearer gates (e.g., answer event, call hold event) or revoking authorization of resources (e.g., SIP session disconnect).

In some embodiments, as part of the policy decision making process, the PDF 206 may need to negotiate with a Bearer Control Function (BCF) network element (not specifically shown) of the IP Backbone network 118 before sending a decision to the requesting GGSN 120. A Bearer Control Function (BCF) performs Quality of Service (QoS) management within the IP Backbone network.

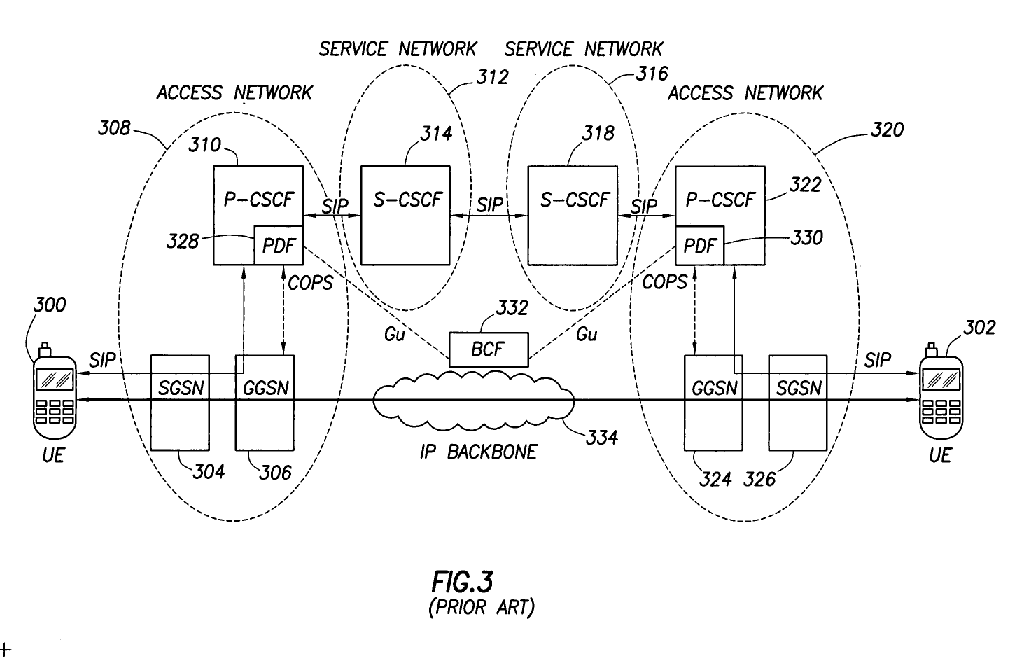

FIG. 3 shows a simplified example of IMS communication involving two roaming IMS mobile users that illustrates the roles of the P-CSCF, the S-CSCF, and the PDF in IMS. In the example, a roaming user of UE 300 initiates an IP call to a roaming user of UE 302. The access networks 308 and 320 are in the cities where the users of UE 300 and UE 302, respectively, are roaming. The service network 312 is the IMS network of the service provider for the user of UE 300 and the service network 316 is the IMS network of the service provider for the user of UE 302. To setup the sessions required to support the IP call, and to maintain those sessions, SIP messages are sent between the UE 300, the SGSN 304, GGSN 306 and P-CSCF 310 of the local access network 308. The P-CSCF 310 also communicates via SIP messages with the S-CSCF 314 of the service network 312. Similarly, SIP messages are sent between the UE 302, the SGSN 326, the GGSN 324, and the P-CSCF 322 of the access network 320, and between the P-CSCF 322 and the S-CSCF 318 of the service network 316. The two S-CSCFs 314 and 318 also communicate via SIP messages.

Within the access network 308, the originating PDF 328 and the originating GGSN 306, communicated via COPS, work with resources within the access network 308 to ensure quality of service. Similarly, the terminating PDF 330 and the terminating GGSN 324 work with resources in the access network 320 to ensure quality of service. If the IP call must go through resources not owned by either of the providers of the access networks 308, 320, the originating PDF 328 and the terminating PDF 330 may negotiate with the BCF 322 that controls those resources to reserve the resources for the call and to determine the QoS available in the end-to-end path between the UEs 300, 302. The protocol of the Gu interface is used for communication between the PDFs 328, 330 and the BCF 332.

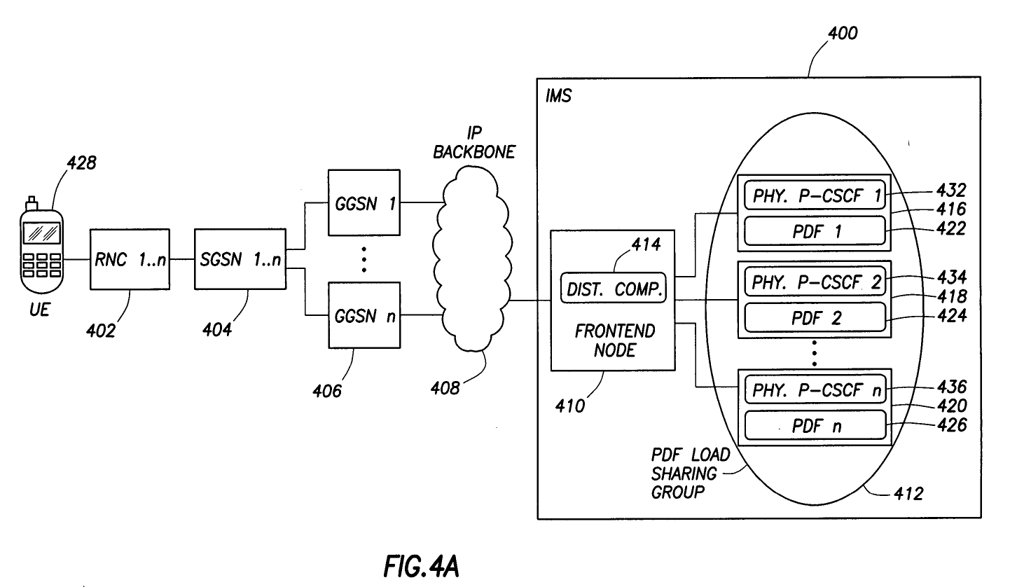

In an IMS implementation, robust performance of a PDF is important. Prior systems have used only one PDF to handle all the calls originating in an area or access point. Using only one PDF create a single point of failure in the event of a problem or overload of the PDF. The message traffic to a PDF may also vary from system to system, so an implementation that supports scalability for handling varying traffic nodes is desirable. The present disclosure, according to one embodiment provides a single logical PDF, but includes multiple physical PDFs which provide redundancy and load sharing and balancing. The present disclosure also provides techniques for identifying the physical PDF and communication session. FIGS. 4A and 4B illustrate embodiments of the present disclosure of telecommunication networks including an IP Multimedia Subsystem with a distributed PDF. In these embodiments, a telecommunications network includes an IMS 400, multiple Radio Network Controllers (RNCs) 402, multiple SGSNs 404, and multiple GGSNs 406. The GGSNs 406 communicate with the IMS 400 via the IP backbone network 408. The IMS 400 includes a front end (or firewall) node 410 and a PDF load sharing group 412. The PDF load sharing group 412 provides a logical PDF network element that comprises multiple physical PDF network elements 422, 424, 426. In the illustrated embodiments, each physical PDF network element 422, 424, 426 execute on a separate computer system 416, 418, 420, respectively. In other embodiments, the physical PDF network elements 422, 424, 426 may execute on separate CPUs in a multiprocessor computer system. In still other embodiments, other arrangements of the physical PDF network elements 422, 424, 426 may be used.

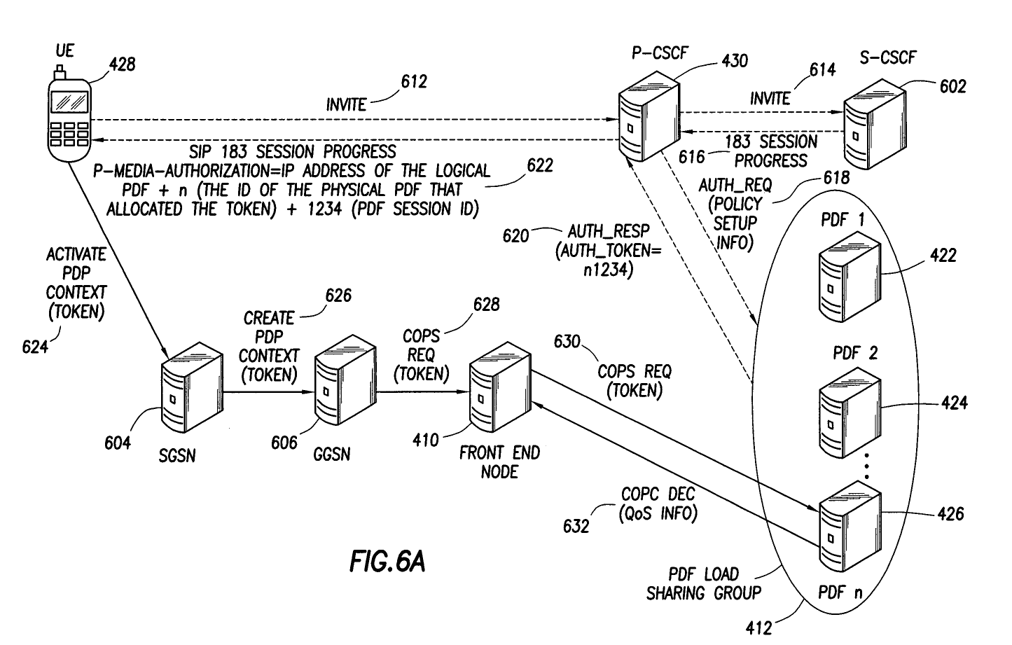

As is explained in more detail below in reference to FIGS. 6A and 6B, when a UE 428 participates in an IP call, P-CSCF 430 uses the PDF Load Sharing Group 412 to select a physical PDF network element 422, 424, 426 to generate an authorization token. Upon receiving an authorization token from the physical PDF network element 422, 424, 426, P-CSCF 430 sends the authorization token to the UE 428. As part of the Resource Reservation procedure, the UE 428 sends the authorization token to GGSN 606, which sends a COPS REQ containing the token to the front end node 410. The front end node 410 uses the PDF ID embedded in the token to route the COPS REQ message to the physical PDF network element 422, 424, 426. A distribution component 414 in the IMS 400 uses a load sharing policy, round robin or other well known load sharing and distributions techniques, to select a physical PDF network element from the PDF load sharing group 412. An authorization token comprising unique identification information for the selected physical PDF network element is communicated back to the UE 428 for use in subsequent messaging traffic between the UE 428 and the IMS 400. In subsequent messaging traffic that requires the participation of the selected physical PDF network element, the GGSN includes this unique identification information so that the front end node 410 can direct that messaging traffic to the selected physical PDF network element.

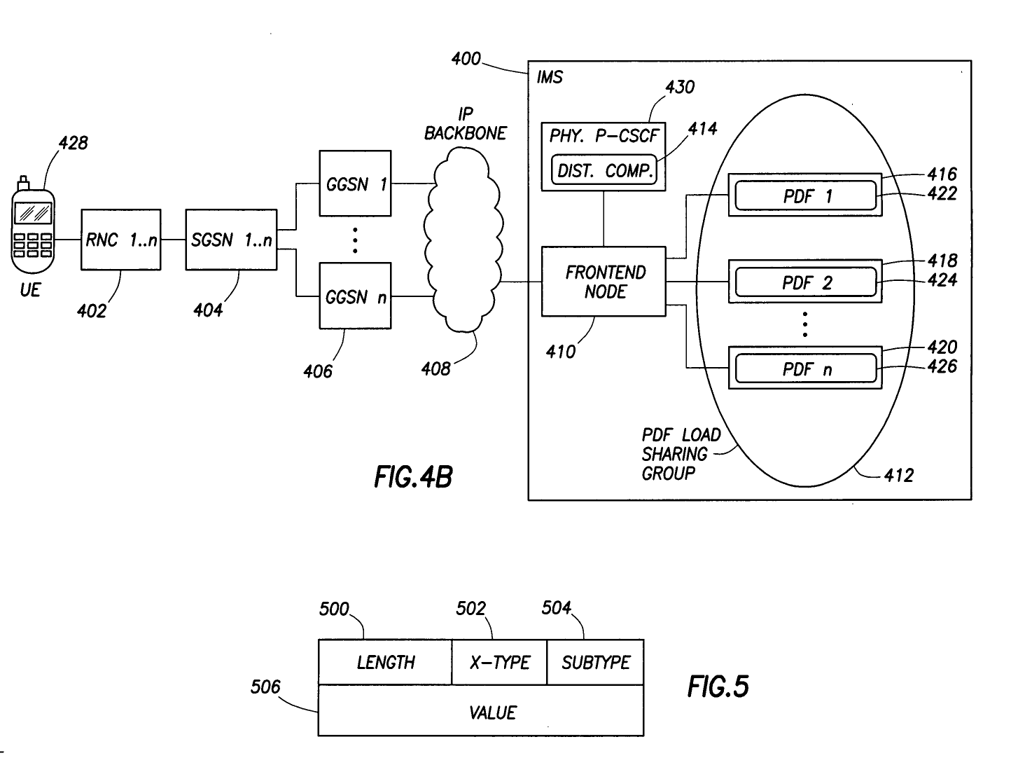

In some embodiments, the authorization token comprises some number of session authorization attributes, each having the format illustrated in FIG. 5. It should be appreciated that the present disclosure is not limited to the illustrated format and, in other embodiments, other authorization tokens having different formats may be used which readily suggest themselves to one skilled in the art. A session authorization attribute comprises a length field 500, an X-Type field 502, a Subtype field 504, and a Value field 506. The length field 500 contains the actual length of the attribute, the X-Type field 502 contains the session authorization attribute type, the Subtype field 504 contains a subtype of the specified session authorization attribute type, and the Value field 506 contains an identifier. To identify the selected physical PDF, the authorization token includes a session authorization attribute in which the X-Type field contains the SESSION_ID X-Type and the Value field 506 contains the IP address of the logical PDF (i.e., the PDF load sharing group 412), the identification of the physical PDF network element, and the identification of the PDF session.

In the IMS 400 illustrated in FIG. 4A, each computing system 416, 418, 420 comprising the PDF load sharing group 412 includes both a physical P-CSCF network element 432, 434, 436 and a physical PDF network element 422, 424, 426 to support faster communication between the two network elements. The distribution component 414 is included in the front end node 410. In the alternate embodiment illustrated in FIG. 4B, the IMS 400 comprises a single physical P-CSCF network element 430 that includes the distribution component 414, and each computing system 416, 418, 420 of the PDF load sharing group 412 includes a single physical PDF network element 422, 424, 426.

FIGS. 6A and 6B illustrate message routing between a UE 428 and the IMS 400 in more detail. These figures assume the IMS embodiment of FIG. 4B having a single physical P-CSCF network element 430. One of skill in the art will appreciate that message routing in the IMS embodiment of FIG. 4A functions in a similar fashion. Also, although all message traffic in an IMS 400 passes through a front end node 410, this is not specifically shown in FIGS. 6A and 6B for simplicity of explanation.

To originate an IP call, the UE 428 sends a SIP INVITE message 612 to the P-CSCF network element 430. The P-CSCF network element 430 sends a SIP INVITE message 614 to S-CSCF network element 602 which sets up a call to the terminating side. The S-CSCF network element 602 responds to the P-CSCF network element 430 with a SIP 183 Session Progress message 616. Upon receipt of this message, the P-CSCF network element 430 calls the distribution component 414 to select a physical PDF network element 422, 424, 426 from the PDF load sharing group 412 to handle policy decisions for the call. In this illustration, the physical PDF network element 426 is selected. The P-CSCF network element 430 sends a Diameter Auth_Req message 618 containing policy setup information to the physical PDF network element 426. The policy setup information may include the IP address of the destination UE, the transport protocol identification, and various bandwidth parameters. The physical PDF network element 426 stores this policy setup information for use in future QoS policy decisions for the IP call.

The physical PDF network element 426 then sends a Diameter Auth_Resp message 620 to the P-CSCF network element 430 containing an authorization token. This authorization token comprises the IP address of the logical PDF (i.e., the PDF load sharing group 412, an identifier (e.g., n) for the physical PDF network element 426, and a PDF session identification number (e.g., 1234). The P-CSCF network element 430 then sends a SIP 183 Session Progress message 622 to the UE 428 that includes the authorization token. The authorization token is embedded in a P-Media-Authorization header.

When the UE 428 receives the authorization token, it generates a flow identifier that identifies an IP media flow associated with the SIP session. This flow identifier combined with the authorization token is sufficient to uniquely identify the IP flow during service delivery. The UE 428 then sends an Activate PDP Context message 624 to the SGSN 604 that includes the authorization token and the flow identifier. The SGSN 604 checks the user profile to authorize the requested QoS and also checks for available resources. The SGSN 604 then sends a Create PDP Context message 626 to the GGSN 606 that contains the authorization token and the flow identifier.

When the GGSN 606 receives the message 626, the Policy Enforcement Point (PEP) in the GGSN 606 sends a COPS REQ message 628 to the logical PDF of the IMS 400 using the IP address of the logical PDF included in the authorization token. The front end node 410 receives the message 628 and extracts the PDF identifier from the authorization token to determine which physical PDF network element in the PDF load sharing group 412 is the intended recipient. In this illustration, the front end node 410 routes the message 630 to the physical PDF network element 426.

The physical PDF network element 426 makes a policy decision based on the previously stored policy setup information. In some embodiments, as is illustrated in FIG. 6B, the physical PDF network element 426 may communicate, via the front end node 410, with a BCF network element 610 to negotiate QoS for resources required for the IP call that are not included in the IMS 400. Such communication between the physical PDF network element 426 and the BCF network element 610, via the front end node 410 may be accomplished using the protocol of the Gu interface. The physical PDF network element 426 sends a Bearer Resource Request message 634 to the front end node 410 which is passed to the BCF network element 610 to request QoS information. The BCF network element 610 responds to this request 634 with a Bearer Resource Allocation ACK message 636 that contains information as to whether the requested QoS can be guaranteed, only lower QoS can be guaranteed, or no QoS can be guaranteed.

In one embodiment, when the physical PDF network element 426 sends a Bearer Resource Request message 634 to the BCF network element 610 via the front end node 410, the message 634 contains the identifier of the physical PDF network element 426 embedded in an attribute of the request message that is also present in the Bearer Resource Allocation ACK message 636. When the front end node 410 receives the ACK message 636 from the BCF network element 610, it extracts the identifier from the message to determine which physical PDF network element is the intended recipient.

In other embodiments, a transaction-based protocol may be used for communication between the physical PDF network element 426 and the BCF network element 610. Using this protocol, when the physical PDF network element 426 sends the request message 634, the front end node maintains a mapping of an identifier for the transaction to the identifier of the physical PDF network element 426. For example, the front end node 410 may maintain a table that associates a unique transaction identifier for the request with the physical PDF identifier. This transaction identifier is included in the allocation acknowledgement message 636. When the front end node 410 receives the allocation acknowledgement message 636, it uses the transaction identifier to determine which physical PDF is the intended recipient.

After making a policy decision, the physical PDF network element 426 sends a COP DEC message 632 back to the GGSN 606 that includes QoS information. This QoS information may comprise a policy decision, a flow identifier, the maximum QoS, and the data rate. The front end node 410 extracts the Client Handle from the COPS DEC message 632 and stores it in a PDF ID mapping table that associates the handle with the identifier of the physical PDF network element 426.

In other message traffic not specifically illustrated in FIG. 6A, the GGSN 606 sends a COPS RPT message back to the logical PDF that includes an acknowledgement and/or error response to the DEC message 632. The front end node 410 extracts the Client Handle from the RPT message and uses it to look in the PDF ID mapping table to determine the identifier of the physical PDF network element in the PDF load sharing group 412 that is the intended recipient (i.e., the PDF network element 426).

The GGSN 606 also checks its own available resources. If sufficient resources are available, the GGSN 606 sends a Create PDP Context Response message back the SGSN 604 containing the negotiated QoS information. The SGSN 604 then sends an Activate PDP Context Accept message to the UE 428 that contains this QoS information. Additional message traffic ensues to enable the use of the authorized QoS resources and to allow packet flow in accordance with the policy decision of the physical PDF network element 426.

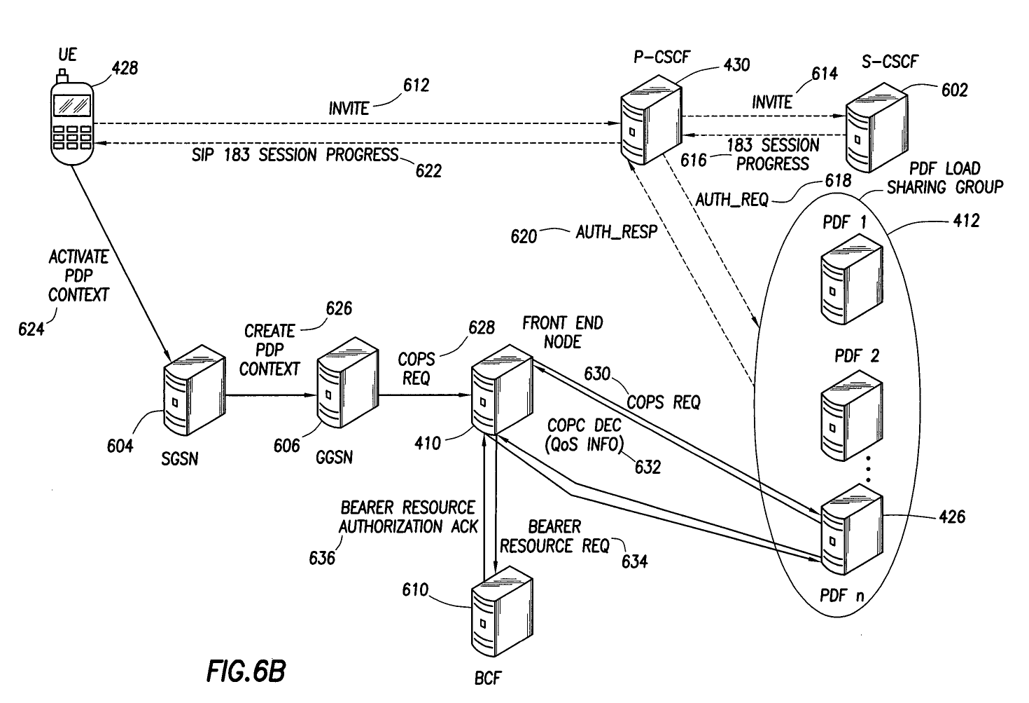

The systems described above may be implemented on one or more computer systems with sufficient processing power, memory resources, and network throughput capability to handle the necessary workload placed upon it. FIG. 7 illustrates a typical, general-purpose computer system suitable for implementing one or more embodiments disclosed herein. The computer system 1200 includes a processor 1332 (which may be referred to as a central processor unit or CPU) that is in communication with memory devices including secondary storage 1338, read only memory (ROM) 1336, random access memory (RAM) 1334, input/output (I/O) devices 1340, and network connectivity devices 1312. The processor 1332 may be implemented as one or more CPU chips.

The secondary storage 1338 is typically comprised of one or more disk drives or tape drives and is used for non-volatile storage of data and as an over-flow data storage device if RAM 1334 is not large enough to hold all working data. Secondary storage 1338 may be used to store programs that are loaded into RAM 1334 when such programs are selected for execution. The ROM 1336 is used to store instructions and perhaps data that are read during program execution. ROM 1336 is a non-volatile memory device that typically has a small memory capacity relative to the larger memory capacity of secondary storage. The RAM 1334 is used to store volatile data and perhaps to store instructions. Access to both ROM 1336 and RAM 1334 is typically faster than to secondary storage 1338.

I/O devices 1340 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 1312 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA) and/or global system for mobile communications (GSM) radio transceiver cards, and other well-known network devices. These network connectivity devices 1312 may enable the processor 1332 to communicate with the Internet or one or more intranets. With such a network connection, it is contemplated that the processor 1332 might receive information from a network or might output information to a network in the course of performing the above-described method steps.

Such information, which may include data or instructions to be executed using processor 1332 for example, may be received from and outputted to the network, for example, in the form of a computer data baseband signal or signal embodied in a carrier wave. The baseband signal or signal embodied in the carrier wave generated by the network connectivity devices 1312 may propagate in or on the surface of electrical conductors, in coaxial cables, in waveguides, in optical media, for example optical fiber, or in the air or free space. The information contained in the baseband signal or signal embedded in the carrier wave may be ordered according to different sequences, as may be desirable for either processing or generating the information or transmitting or receiving the information. The baseband signal or signal embedded in the carrier wave, or other types of signals currently used or hereafter developed, referred to herein as the transmission medium, may be generated according to several methods well known to one skilled in the art.

The processor 1332 executes instructions, codes, computer programs, or scripts that it accesses from hard disk, floppy disk, optical disk (these various disk-based systems may all be considered secondary storage 1338), ROM 1336, RAM 1334, or the network connectivity devices 1312.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein, but may be modified within the scope of the appended claims along with their full scope of equivalents. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as directly coupled or communicating with each other may be coupled through some interface or device, such that the items may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

What is claimed is:

1. An Internet Protocol (IP) Multimedia Subsystem (IMS) comprising:
a logical Policy Decision Function (PDF) component comprising a plurality of physical PDF network elements; and
a front end node operable to determine which one of the plurality of physical PDF network elements is an intended recipient of a message by using identification information in an authorization token portion of the message.

2. The IMS of claim 1, further comprising a distribution component operable to select one of the plurality of physical PDF network elements according to a load sharing policy.

3. The IMS of claim 1, wherein the distribution component generates the authorization token comprising the identification information for the selected one of the plurality of physical PDF network elements.

4. The IMS of claim 2, wherein the distribution component is a component of the front end node.

5. The IMS of claim 2, where in the distribution component is comprised in a Proxy Call Session Control Function (P-CSCF).

6. The IMS of claim 1, further comprising a distribution component operable to select another of the plurality of plurality of physical PDF network elements when one of the plurality of physical PDF network elements fails.

7. The IMS of claim 1, wherein the logical PDF comprises a plurality of physical Proxy Call Session Control Function (P-CSCF) network elements, each physical P-CSCF network element associated with one of the physical PDF network elements and executing on the same CPU as the associated PDF network element.

8. The IMS of claim 2, wherein the identification information comprises an IP address of the logical PDF component, an identifier for the physical PDF network element selected by the distribution component, and an identifier for a PDF session of the physical PDF network element selected by the distribution component.

9. The IMS of claim 1, wherein the authorization token is generated responsive to an authorization request message from a P-CSCF.

10. The IMS of claim 2, wherein the physical PDF network element selected by the distribution component negotiates quality of service with a Bearer Control Function (BCF), and wherein the selected physical PDF network element includes identification information in a bearer resource request message send to the BCF, the BCF includes the identification information in a bearer resource allocation acknowledgment message sent to the selected physical PDF network element, and the front end node is operable to extract the identification information from the bearer resource allocation acknowledgment message to determine that the selected physical PDF network element is the intended recipient of the acknowledgement message.

11. The IMS of claim 1, wherein the physical PDF network element selected by the distribution component negotiates quality of service with a Bearer Control Function (BCF), and wherein the front end node is operable to store a transaction identifier for a bearer resource request message sent to the BCF by the selected physical PDF network element, the transaction identifier associated with an identifier of the selected physical PDF network element, the front end node further operable to extract the transaction identifier from a bearer resource allocation acknowledgment message send by the BCF to determine that the selected physical PDF network element is the intended recipient of the acknowledgement message.

12. A method for distributing Policy Decision Function (PDF) in an Internet Protocol (IP) Multimedia Subsystem (IMS), the method comprising:
providing a plurality of physical PDF network elements that comprise a logical PDF, each of the plurality of physical PDF network elements executing on a separate central processing unit (CPU);
receiving a message intended for one of the plurality of physical PDF network elements;
determining from an identifier in the message which of the plurality of physical PDF network elements the message is intended for; and
delivering the message to the intended one of the plurality of physical PDF network elements.

13. A method of claim 12, further comprising:
load balancing between the plurality of physical PDF network to handle policy decisions for an IP call in accordance with a load sharing policy

14. The method of claim 12, further comprising
the PDF identifying a session related to the message based on a session identifier in the message.

15. The method of claim 12, further comprising:
receiving a SIP INVITE message from a user element to a front end node associated with the plurality of physical PDF network elements.

16. The method of claim 12, further comprising:
responsive to a SIP 183 Progress Message from a Serving Call System Control Function (S-CSCF) network element, selecting one of the plurality of physical PDF network element to handle policy decisions for an IP call, the selection made in accordance with a load sharing policy;
generating an authorization token comprising the identifier for the selected physical PDF network element; and
sending the authorization token to a user element, wherein the user element uses the authorization token to indicate that the message is intended for the selected physical PDF network element.

17. The method of claim 12, further comprising:
sending a Common Open Policy Service (COPS) REQ message to request Quality of Service information, the message comprising the authorization token to an IP address of the logical PDF included in the authorization token;
extracting the identifier of the intended physical PDF network element from an authorization token associated with the message; and
forwarding the COPS REQ message to the intended and identified physical PDF network element.

18. The method of claim 12, further comprising:
negotiating Quality of Service with a Bearer Control Function (BCF) network element wherein the negotiating comprises:
responsive to the COPS REQ message, sending a bearer resource request message comprising the identifier of a selected one of the plurality of physical PDF network element to the BCF network element;
responsive to the bearer resource request message, receiving a bearer resource allocation acknowledgment message comprising the identifier of the selected physical PDF network element from the BCF network element; and
extracting the identifier from the acknowledgment message to determine that the selected physical PDF network element is the intended recipient of the acknowledgment message.

19. An Internet Protocol (IP) Multimedia Subsystem (IMS) comprising:
a plurality of separate central processing units (CPUs);
a logical Policy Decision Function (PDF) component comprising a plurality of physical PDF network elements, each physical PDF network element executing on separate CPUs of the plurality of CPUs;
a front end node operable to determine which one of the plurality of physical PDF network elements is an intended recipient of a message by using identification information in an authorization token portion of the message; and
a distribution component operable to select one of the plurality of physical PDF network elements according to a load sharing policy.

20. The IMS of claim 20, further comprising the message having a session identifier operable for use by the intended one of the plurality of physical PDF network elements to identify a session associated with the message.
